(19) United States
(12) Patent Application Publication
(10) Pub. No.: US 2026/0268703 A1
(43) Pub. Date: Sep. 10, 2026

(54) IMAGE PROCESSING DEVICE, IMAGE PROCESSING METHOD, AND NON-TRANSITORY COMPUTER-READABLE MEDIUM

(71) Applicant: NEC Corporation, Tokyo (JP)

(72) Inventors: Masahito SAKAI, Tokyo (JP); Kosuke TONO, Tokyo (JP); Daisuke MORI, Tokyo (JP); Hisahiro OBA, Tokyo (JP)

(73) Assignee: NEC Corporation, Tokyo (JP)

(21) Appl. No.: 19/162,565

(22) PCT Filed: Mar. 23, 2023
(86) PCT No.: PCT/JP2023/011578

§ 371 Date: Sep. 5, 2025

(51) Int. Cl. G06V 40/10; G06F 21/62; G06T 3/4038; G06T 5/70; G06T 11/40; G06T 11/60; G06V 20/58; G06V 40/16

(52) U.S. Cl. CPC G06V 40/103; G06F 21/6254; G06T 3/4038; G06T 5/70; G06T 11/40; G06T 11/60; G06V 20/58; G06V 40/161; G06T 2207/10016; G06T 2207/30201; G06T 2207/30252

(57) ABSTRACT

An image processing device comprises an image acquisition unit that acquires an image, a person region detection unit that detects a person region presumed to be a person from the image, a person likelihood calculation unit that calculates a likelihood for the person detected at detection of the person region, a first masking unit that masks at least a portion of the person region when the calculated likelihood for the person is at or above a threshold value, a face region detection unit that detects a face region presumed to be the face of the person from the image for which the person region was detected, and a second masking unit that masks at least a portion of the person region and the face region when the calculated likelihood for the person is below the threshold value and the person region and the face region satisfy a prescribed condition.

### TECHNICAL FIELD

The present disclosure relates to an image processing device, an image processing method, and a non-transitory computer-readable medium.

### BACKGROUND ART

Videos acquired by an imaging device such as a drive recorder provided in a vehicle are collected and used for various purposes. In a case where a person or the like is shown in a video, from the perspective of personal information protection, masking processing may be performed on a region where the person is shown.

PTL 1 describes a technology of performing concealment processing such as mosaicing or blurring on a region of a non-monitored person subject to privacy protection based on an evaluation value for each person.

### CITATION LIST

### Patent Literature

PTL 1: JP 2011-130203 A

### SUMMARY OF INVENTION

### Technical Problem

However, there is a case where a person cannot be appropriately detected. Therefore, there is a case where the masking processing on the detected person cannot be performed for personal information protection.

The present disclosure has been made to solve such a problem, and an object of the present disclosure is to provide an image processing device, an image processing method, and a non-transitory computer-readable medium capable of accurately detecting a region of a person from an image and performing masking processing.

### Solution to Problem

According to an aspect of the present disclosure, there is provided an image processing device including
an image acquisition unit that acquires an image,
a person region detection unit that detects a person region estimated to be a person from the image,
a person likelihood calculation unit that calculates likelihood of the person detected at a time of detecting the person region,
a first masking unit that masks at least a part of the person region in a case where the calculated likelihood of the person is equal to or more than a threshold,
a face region detection unit that detects a face region estimated to be a face of the person from the image in which the person region is detected, and
a second masking unit that masks at least a part of the person region and the face region in a case where the calculated likelihood of the person is less than the threshold and the person region and the face region satisfy a predetermined condition.

According to another aspect of the present disclosure, there is provided an image processing method including
acquiring an image,
detecting a person region estimated to be a person from the image,
calculating likelihood of the person detected at a time of detecting the person region,
masking at least a part of the person region in a case where the calculated likelihood of the person is equal to or more than a threshold,
detecting a face region estimated to be a face of the person from the image in which the person region is detected, and
masking at least a part of the person region and the face region in a case where the calculated likelihood of the person is less than the threshold and the person region and the face region satisfy a predetermined condition.

According to still another aspect of the present disclosure, there is provided a non-transitory computer-readable medium storing a program that causes a computer to
acquire an image,
detect a person region estimated to be a person from the image,
calculate likelihood of the person detected at a time of detecting the person region,
mask at least a part of the person region in a case where the calculated likelihood of the person is equal to or more than a threshold,
detect a face region estimated to be a face of the person from the image in which the person region is detected, and
mask at least a part of the person region and the face region in a case where the calculated likelihood of the person is less than the threshold and the person region and the face region satisfy a predetermined condition.

### Advantageous Effects of Invention

According to the present disclosure, it is possible to provide an image processing device and the like capable of accurately detecting a region of a person from an image and performing masking processing.

### BRIEF DESCRIPTION OF DRAWINGS

FIG. 1 is a block diagram illustrating a configuration of an image processing device according to a first example embodiment.

FIG. 2 is a diagram illustrating an example of an acquired video frame according to the first example embodiment.

FIG. 3 is a diagram illustrating another example of an acquired video frame according to the first example embodiment.

FIG. 4 is a flowchart illustrating an image processing method according to the first example embodiment.

FIG. 5 is a block diagram illustrating a configuration of an image processing system according to a second example embodiment.

FIG. 6 is a block diagram illustrating a configuration of an image processing device according to the second example embodiment.

FIG. 7 is a flowchart illustrating an image processing method according to the second example embodiment.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description.

### First Example Embodiment

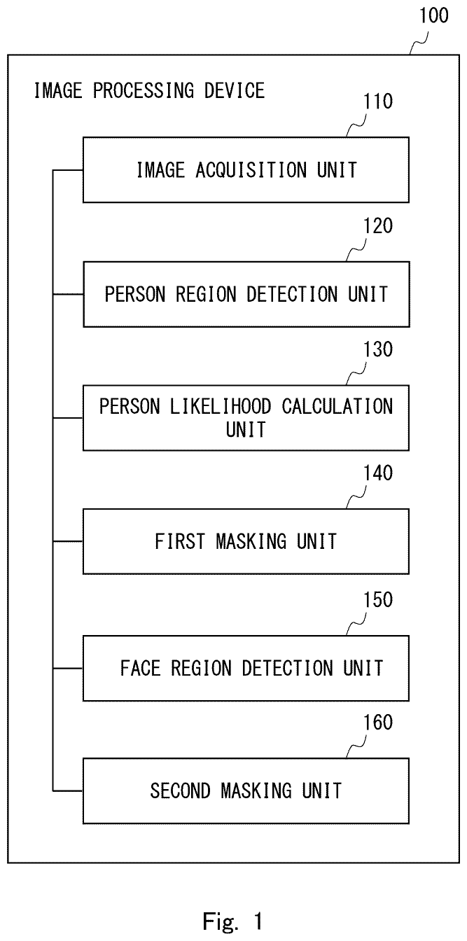

FIG. 1 is a block diagram illustrating a configuration of an image processing device 100 according to a first example embodiment. In a case where an image acquired from an imaging device that images the surroundings of a vehicle includes a person, the image processing device 100 performs masking processing for concealing the person, their clothing, and the like in such a way as not to be able to be identified. The image processing device 100 includes an image acquisition unit 110, a person region detection unit 120, a person likelihood calculation unit 130, a first masking unit 140, a face region detection unit 150, and a second masking unit 160. The image processing device 100 can be implemented by a computer including a processor and a memory. The image processing device 100 is connected to a wired or wireless network (not illustrated). An imaging device (not illustrated) or the like that images the surroundings of a vehicle is connected to the network. A video captured by the imaging device is a moving image and includes a plurality of consecutive frames arranged in chronological order of an imaging time. Here, a frame is still image data captured by the imaging device.

The image acquisition unit 110 acquires image frames of a video captured by the imaging device installed in the vicinity of a vehicle, a road, or the like. The video includes a plurality of frames. The video captured by the imaging device is transmitted to the image processing device 100 via the network.

The person region detection unit 120 detects a person region estimated to be a person from the video acquired by the image acquisition unit 110. Specifically, the person region detection unit 120 detects the person region for each frame included in the video using a known person region detection engine.

The person likelihood calculation unit 130 calculates the likelihood of a person detected at the time of detecting the person region using the known person region detection engine. In general, the likelihood of a person is a value in a range of 0% to 100%, and the higher the value, the higher the probability that the detected object is a person. The person likelihood is also referred to as a person detection score. The person detection score has a higher numerical value in a region having a high possibility that a person exists, than another region. The threshold of a predetermined person detection score is a preset numerical value and is used when the person is detected from the frame included in the video. The threshold of the person detection score may be set to a value different according to the region in the frame. In the present specification, the machine learning may be deep learning, but the machine learning is not particularly limited. A method for calculating the person detection score is not limited to the above, and other existing technologies can be applied.

In a case where the calculated likelihood of a person is equal to or more than a threshold (for example, 80% or more), the first masking unit 140 can mask at least a part (a part corresponding to a face, clothing, or the like) or all of the person region. That is, in a case where it is highly likely that the object detected by a person detection engine is a person, the first masking unit 140 performs various concealment processing in such a way that the person cannot be identified. Examples of masking include filling, mosaicing, and blurring on at least a part of the person region and the face region, but are not limited to thereto. Various masking methods that can be understood by those of ordinary skill in the art can be employed. In some example embodiments, an at least partially expanded range of the person region can be masked.

In a case where the calculated likelihood of a person is less than a threshold (for example, less than 80%), the face region detection unit 150 detects a face region estimated to be the face of the person from the image in which the person region is detected. Specifically, the face region detection unit 150 detects the face region of the person for each frame included in the video using a known person's face region detection engine. The face region detection unit 150 also detects the face region of the person for the image frame in which the person region detection unit 120 detects the person region. The recognition accuracy of the person detection engine and the person face detection engine described above may be different even for the same person. In some examples, for example, the recognition accuracy of the person face detection engine may be higher than the person recognition accuracy of the person detection engine.

In a case where the calculated likelihood of a person is less than a threshold (for example, less than 80%) and the person region and the face region satisfy a predetermined condition, the second masking unit 160 masks at least a part or all of the person region and the face region. The masking methods of the first masking unit 140 and the second masking unit 160 may be basically the same. The predetermined condition includes, for example, the degree of overlap between the person region and the face region being equal to or more than a threshold, a distance between the person region and the face region being equal to or more than a threshold, and a positional relationship between the person region and the face region. Details thereof will be described below.

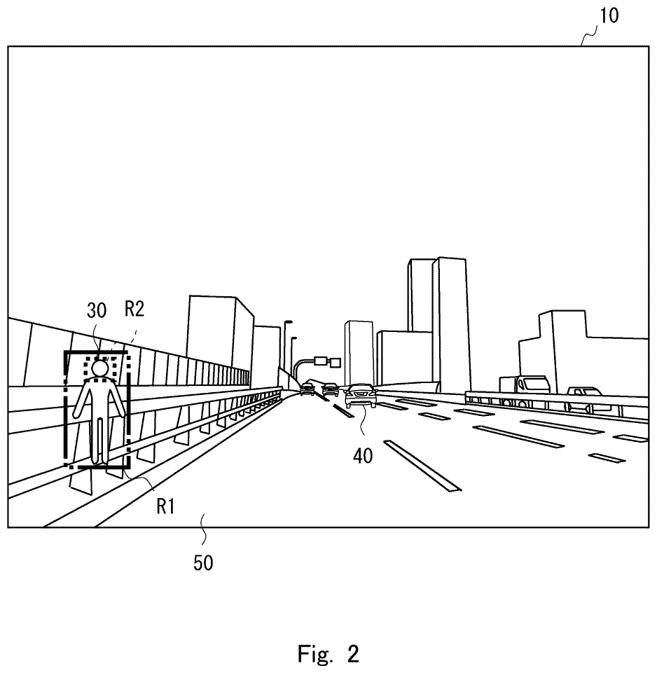

FIG. 2 illustrates an example of a frame 10 included in the acquired video. In the frame 10 illustrated in FIG. 2, a person 30 walking on a sidewalk and a vehicle 40 traveling forward on a roadway 50 are shown. In the example in FIG. 2, the person region detection unit 120 detects a person region R1 that is a region including an image of the person 30. The person likelihood calculation unit 130 calculates the likelihood of a person, and the calculated likelihood is less than a threshold (for example, less than 80%, for example, 50%). In this case, it is uncertain whether the object is a person. For example, in the case of nighttime or rainy weather, the person detection accuracy of the person region detection unit 120 may decrease. Therefore, in the present disclosure, the face region detection engine is used to determine that the object is highly likely to be a person, and the masking processing is performed to ensure personal information protection. Specifically, the face region detection unit 150 performs face detection processing on the same frame 10 in which the person region is detected. In FIG. 2, a detected face region R2 of the person is included in the detected person region R1. That is, the degree of overlap between the person region R1 and the face region R2 is 100% (>Threshold=20%, 30%, 50%, or the like). Therefore, when the condition that the degree of overlap between the person region and the face region is equal to or more than a threshold is satisfied, the second masking unit 160 can determine that the object is a person with a high possibility, and masks at least a part of the person region and the face region.

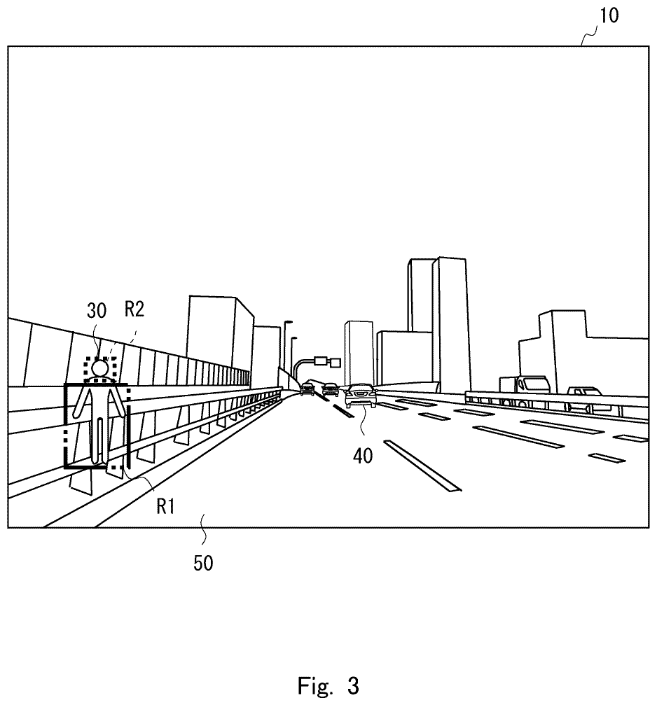

FIG. 3 illustrates another example of the frame 10 included in the acquired video.

In the example of FIG. 3, the person region R1 detected by the person region detection unit 120 includes only the body part of the person 30. In this case, the face region R2 detected by the face region detection unit 150 is not included in the person region R1. That is, since the degree of overlap between the person region R1 and the face region R2 is 0% (<Threshold=20%), the masking processing is not executed under the condition described above. However, since the distance between the person region R1 and the face region R2 is equal to or less than a threshold (the person region R1 and the face region R2 are close to each other), the second masking unit can determine that the object is highly likely to be a person, and mask at least a part of the person region and the face region. In order to identify the distance between the person region R1 and the face region R2, a distance between the center of the rectangle indicating the person region R1 (or the center of the upper portion of the rectangle) and the center of the rectangle indicating the face region R2 can be used.

The predetermined condition described here is merely an example, and various conditions for determining that the object is a person based on the relationship between the person region and the face region, which can be understood by those of ordinary skill in the art, can be used. Although not illustrated, the likelihood of a person may be displayed on a display screen together with the detected person region.

The image processing device 100 includes a processor, a memory, and a storage device as components (not illustrated). The storage device stores a computer program in which processing of the image processing method according to the present example embodiment is implemented. The processor loads the computer program from the storage device into the memory and executes the computer program. Thus, the processor achieves functions as the image acquisition unit 110, the person region detection unit 120, the person likelihood calculation unit 130, the first masking unit 140, the face region detection unit 150, and the second masking unit 160.

The image acquisition unit 110, the person region detection unit 120, the person likelihood calculation unit 130, the first masking unit 140, the face region detection unit 150, and the second masking unit 160 may be implemented by dedicated hardware. Some or all of the components of each device may be implemented by general-purpose or dedicated circuitry, a processor, or a combination thereof. These components may be configured with a single chip or may be configured with a plurality of chips connected via a bus. Some or all of the components of each device may be implemented by a combination of the above-described circuitry or the like and a program. A central processing unit (CPU), a graphics processing unit (GPU), a field-programmable gate array (FPGA), or the like can be used as the processor.

In a case where some or all of the components of the image processing device 100 are implemented by a plurality of information processing devices, circuitry, or the like, the plurality of information processing devices, circuitry, or the like may be centralized or distributed. For example, each of the information processing devices, circuitry, or the like may be implemented in the form of a client server system, a cloud computing system, or the like in which they are connected to each other through a communication network. A function of the image processing device 100 may be provided in a software as a service (SaaS) format.

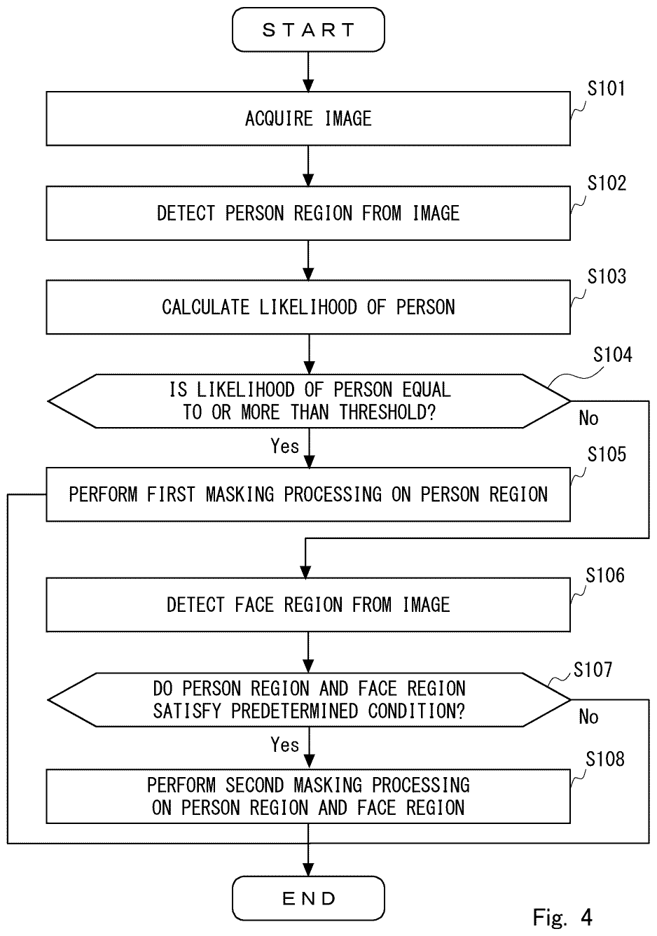

FIG. 4 is a flowchart illustrating the image processing method according to the first example embodiment.

The image acquisition unit 110 acquires image frames of a video captured by the imaging device installed in the vicinity of a vehicle, a road, or the like (step S101). The acquired image frames are stored in the storage device together with an acquired time, an acquired positional information (for example, latitude, longitude, and the like), and other information (for example, the weather at the position).

The person region detection unit 120 detects a person region estimated to be a person from the video acquired by the image acquisition unit 110 using the known person region detection engine (step S102). The person likelihood calculation unit 130 calculates the likelihood of a person detected at the time of detecting the person region using the known person region detection engine (step S103). In general, the person region detection and the person likelihood calculation can be simultaneously executed using the person region detection engine.

In a case where the calculated likelihood of a person is equal to or more than a threshold (that is, in a case where the probability that the detected object is a person is high) (Yes in step S104), the first masking unit 140 masks at least a part or all of the person region (step S105). Thereafter, the image processing ends. Thus, in a case where the probability that the object detected in the image frame is a person is high, the person concealment processing is performed using the person region detection engine.

On the other hand, even in a case where the calculated likelihood of a person is less than a threshold (that is, in a case where the probability that the detected object is a person is relatively low) (No in step S104), the personal information protection can be reliably performed by performing the masking processing in a case where a predetermined condition is satisfied. The face region detection unit 150 detects a face region estimated to be the face of the person from the image in which the person region is detected (step S106). Next, in a case where the detected person region and face region satisfy a predetermined condition (Yes in step S107), the second masking unit 160 masks at least a part of the person region and the face region (step S108). Thus, even in a case where the detection accuracy of the person detection engine is not good (for example, due to external environmental factors such as weather), it is possible to accurately detect a person whose personal information is to be protected and perform masking processing.

### Second Example Embodiment

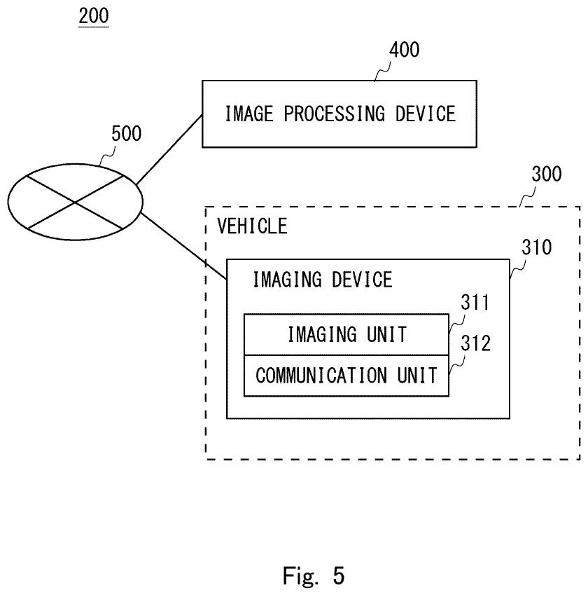

FIG. 5 is a block diagram illustrating a configuration of an image processing system 200 according to a second example embodiment. The image processing system 200 may include at least an imaging device 310 and an image processing device 400. The imaging device 310 is connected to the image processing device 400 via a network 500. Description overlapping with the first example embodiment will be omitted as appropriate.

The image processing system 200 is a system for detecting a person from a video captured by the imaging device 310 provided in a vehicle 300. The vehicle 300 is, for example, an automobile and may be a vehicle other than the automobile such as a motorcycle or a bicycle. The imaging device 310 is provided in the vehicle 300. The imaging device 310 is a device that images a scene around the vehicle 300 and is, for example, a drive recorder. The imaging device 310 includes an imaging unit 311 and a communication unit 312. The imaging unit 311 is a camera. The imaging unit 311 images, for example, a scene in front of the vehicle 300, that is, a scene that a driver sitting in a driver's seat of the vehicle 300 can see. The orientation of the imaging unit 311 can be arbitrarily changed or may be in all directions. The communication unit 312 is a communication interface with the network 500. The communication unit 312 transmits the video captured by the imaging unit 311 to the image processing device 400 via the network 500.

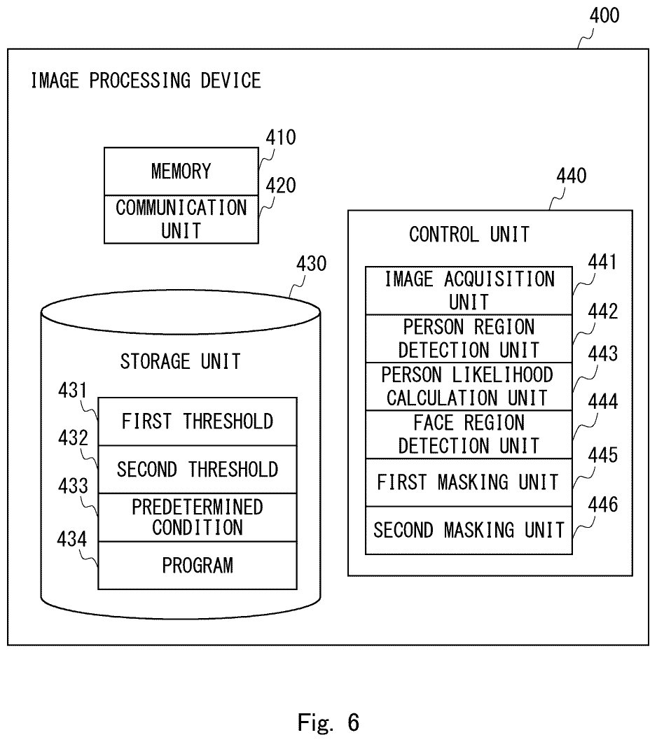

Next, a configuration of the image processing device 400 will be described in detail with reference to FIG. 6. FIG. 6 is a block diagram illustrating the configuration of the image processing device 400. The image processing device 400 includes a memory 410, a communication unit 420, a storage unit 430, and a control unit 440.

The memory 410 is a storage area for temporarily storing processing content of the control unit 440, and is, for example, a volatile storage device such as a random access memory (RAM). The communication unit 420 is an interface that communicates with the outside of the image processing device 400. The storage unit 430 is a storage device that stores a first threshold 431 and a second threshold 432 of the person likelihood, a predetermined condition 433, and a program 434. The first threshold 431 of the person likelihood can be, for example, 80%, and is a numerical value used when a first masking unit 445 (to be described later) determines whether to mask a person detected from a frame included in the video. The first threshold 431 of the person likelihood may be set to a different value for each frame or according to a region in the frame. The second threshold 432 of the person likelihood can be, for example, 20%. In a case where the detected person likelihood is less than the second threshold 432, the first masking unit 445 determines that the detected object is not a masking processing target, and refrains from performing the masking processing.

In a case where the person likelihood is less than the first threshold 431 and equal to or more than the second threshold 432, there is a possibility that the detected object is a person whose personal information is to be protected. Therefore, the predetermined condition 433 defines another condition for the masking processing. The predetermined condition 433 includes the degree of overlap between the person region and the face region being equal to or more than a threshold, a distance between the person region and the face region being equal to or more than a threshold, and a positional relationship between the person region and the face region. The program 434 is a computer program in which image processing treatment according to the present example embodiment is implemented.

The control unit 440 includes an image acquisition unit 441, a person region detection unit 442, a person likelihood calculation unit 443, a face region detection unit 444, a first masking unit 445, and a second masking unit 446. The control unit 440 is a control device that controls an operation of the image processing device 400 and is, for example, a processor such as a CPU. The control unit 440 loads the program 434 from the storage unit 430 into the memory 410 and executes the program. Thus, the control unit 440 achieves functions as the image acquisition unit 441, the person region detection unit 442, the person likelihood calculation unit 443, the face region detection unit 444, the first masking unit 445, and the second masking unit 446.

The image acquisition unit 441 acquires the video transmitted from the imaging device 310. The video includes a plurality of consecutive frames. The video may include identification information and time information. The identification information is information for identifying the vehicle 300 in which the imaging device 310 that captures the video is provided. The time information is information regarding a time when the video is captured.

The person region detection unit 442 detects the person region for each frame included in the video acquired by the image acquisition unit 110. The person likelihood calculation unit 443 calculates the person likelihood in the person region detected by the person region detection unit 442. The face region detection unit 444 detects a face region estimated to be the face of the person from the image frame in which the person region is detected. In some example embodiments, the person region detection unit 442 can also identify attributes (for example, age, gender, race, and the like) of a person.

The first masking unit 445 performs masking processing on the detected object in the frame when the calculated likelihood of a person is equal to or more than a first threshold (for example, 80% or more). On the other hand, the first masking unit 445 can refrain from performing the masking processing on the detected object in the frame when the calculated likelihood of a person is equal to or more than a second threshold (for example, less than 20%).

In a case where the likelihood of a person is less than the first threshold (for example, less than 80%) and equal to or more than the second threshold (for example, 20% or more), it can be determined that the detected object is a person based on the relationship between the person region detected by the person region detection unit 442 and the face region detected by the face region detection unit 444.

In a case where the calculated likelihood of a person is less than the first threshold and equal to or more than the second threshold and in a case where the person region and the face region satisfy a predetermined condition, the second masking unit 446 masks at least a part of the person region and the face region. Here, the masking processing is image processing performed on the region in such a way as not to be able to identify the person and includes solid fill processing and filter processing. The first masking unit 445 and the second masking unit 446 may perform masking processing on a part of the person image region (for example, a part corresponding to the face). The masking processing includes filling, mosaicing, or blurring. The masking processing can be replaced with an avatar corresponding to the attribute of the person while complying with personal information protection.

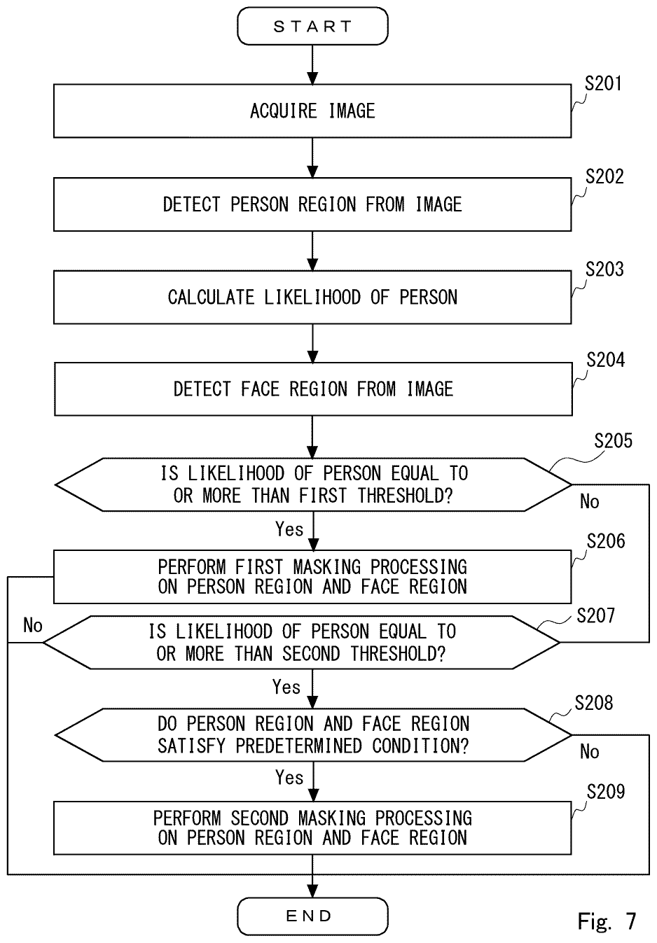

Next, an image processing method according to the second example embodiment will be described with reference to FIG. 7.

The image acquisition unit 441 acquires image frames of a video captured by the imaging device installed in the vicinity of a vehicle, a road, or the like (step S201). The acquired image frames are stored in the storage device together with an acquired time, an acquired positional information (for example, latitude, longitude, and the like), and other information (for example, the weather at the position).

The person region detection unit 442 detects a person region estimated to be a person from the video acquired by the image acquisition unit 441 using the known person region detection engine (step S202). The person likelihood calculation unit 443 calculates the likelihood of a person detected at the time of detecting the person region using the known person region detection engine (step S203). In general, the person region detection and the person likelihood calculation can be simultaneously executed using the person detection engine. The face region detection unit 444 detects a face region estimated to be the face of the person from the image frame in which the person region is detected (step S204).

In a case where the calculated likelihood of a person is equal to or more than the first threshold (that is, in a case where the probability that the detected object is a person is high) (Yes in step S205), the first masking unit 415 masks at least a part or all of the person region and the face region (step S206). Thus, in a case where the probability that the object detected in the image frame is a person is high in the person detection engine, the person concealment processing is performed. Thereafter, the image processing ends.

On the other hand, even in a case where the calculated likelihood of a person is less than the first threshold (for example, 80%) (that is, in a case where the probability that the detected object is a person is relatively low) (No in step S205) and even in a case where the calculated likelihood of a person is equal to or more than the second threshold (for example, 20%) (Yes in step S207), the masking processing is performed in a case where a predetermined condition below is satisfied. Thus, it is possible to ensure personal information protection. In a case where the detected person region and face region satisfy the predetermined condition (Yes in step S208), the second masking unit 416 masks at least a part of the person region and the face region (step S209). Thus, even in a case where the detection accuracy of the person detection engine is not good (for example, due to external environmental factors such as weather), it is possible to accurately detect a person whose personal information is to be protected and perform masking processing by using the detection result of the face region detection engine.

In a case where the calculated likelihood of a person is less than the second threshold (for example, 20%) (that is, in a case where the probability that the detected object is a person is very low) (No in step S207), it is determined that the detected object is not a person, and the masking processing can be skipped. Thus, the collected images can be used for many purposes.

In the above-described example embodiments, the configuration of the hardware has been described, but the present disclosure is not limited thereto. According to the present disclosure, the processing illustrated in FIGS. 4 and 7 can also be achieved by causing a CPU to execute a computer program.

In the example described above, the program includes a group of instructions (or software codes) for causing a computer to execute one or more functions described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or another memory technology, a CD-ROM, a digital versatile disc (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. As an example and not by way of limitation, transitory computer-readable or communication media include electrical, optical, acoustic, or other forms of propagated signals.

Note that the present disclosure is not limited to the above-described example embodiments, and can be appropriately changed without departing from the scope. The present disclosure may be implemented by appropriately combining the example embodiments. The masking target can include not only the face of the person but also clothing with which a person can be identified. The functions of the person region detection unit 120, the person likelihood calculation unit 130, the first masking unit 140, the face region detection unit 150, and the second masking unit 160 of the image processing device 100 may be provided in the imaging device 310 of each vehicle 300. Similarly, the functions of the person region detection unit 442, the person likelihood calculation unit 443, the face region detection unit 444, the first masking unit 445, and the second masking unit 446 of the image processing device 400 may be provided in the imaging device 310 of each vehicle 300. Thus, the imaging device 310 of each vehicle 300 can individually detect a person and execute masking processing.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

Some or all of the above-described example embodiments may also be described as the following supplementary notes, but are not limited to the following supplementary notes.

### (Supplementary Note 1)

An image processing device including:
an image acquisition unit that acquires an image;
a person region detection unit that detects a person region estimated to be a person from the image;
a person likelihood calculation unit that calculates likelihood of the person detected at a time of detecting the person region;
a first masking unit that masks at least a part of the person region in a case where the calculated likelihood of the person is equal to or more than a threshold;
a face region detection unit that detects a face region estimated to be a face of the person from the image in which the person region is detected; and
a second masking unit that masks at least a part of the person region and the face region in a case where the calculated likelihood of the person is less than the threshold and the person region and the face region satisfy a predetermined condition.

### (Supplementary Note 2)

The image processing device according to Supplementary Note 1, in which the predetermined condition is that a degree of overlap between the person region and the face region is equal to or more than a threshold.

### (Supplementary Note 3)

The image processing device according to Supplementary Note 1, in which the predetermined condition is that a distance between the person region and the face region is equal to or less than a threshold.

### (Supplementary Note 4)

The image processing device according to Supplementary Note 1, in which the masking includes filling, mosaicing, or blurring on at least a part of the person region and the face region.

### (Supplementary Note 5)

The image processing device according to Supplementary Note 1, in which the masking includes disposing an avatar on the person region and the face region.

### (Supplementary Note 6)

The image processing device according to Supplementary Note 1, in which the image acquisition unit acquires an image captured by an imaging device provided in a vehicle.

### (Supplementary Note 7)

An image processing method including:
acquiring an image;
detecting a person region estimated to be a person from the image;
calculating likelihood of the person detected at a time of detecting the person region;
masking at least a part of the person region in a case where the calculated likelihood of the person is equal to or more than a threshold;
detecting a face region estimated to be a face of the person from the image in which the person region is detected; and
masking at least a part of the person region and the face region in a case where the calculated likelihood of the person is less than the threshold and the person region and the face region satisfy a predetermined condition.

### (Supplementary Note 8)

A non-transitory computer-readable medium storing a program that causes a computer to:
acquire an image;
detect a person region estimated to be a person from the image;
calculate likelihood of the person detected at a time of detecting the person region;
mask at least a part of the person region in a case where the calculated likelihood of the person is equal to or more than a threshold;
detect a face region estimated to be a face of the person from the image in which the person region is detected; and
mask at least a part of the person region and the face region in a case where the calculated likelihood of the person is less than the threshold and the person region and the face region satisfy a predetermined condition.

### REFERENCE SIGNS LIST

10 frame
30 person
40 vehicle
50 roadway
100 image processing device
110 image acquisition unit
120 person region detection unit
130 person likelihood calculation unit
140 first masking unit
150 face region detection unit
160 second masking unit
400 image processing device
410 memory
420 communication unit
430 storage unit
431 first threshold
432 second threshold
433 predetermined condition
434 program
440 control unit
441 image acquisition unit
442 person region detection unit
443 person likelihood calculation unit
444 face region detection unit
445 first masking unit
446 second masking unit
200 image processing system
300 vehicle
310 imaging device
311 imaging unit
312 communication unit
500 network
R1 person region
R2 face region

What is claimed is:

1. An image processing device comprising:
at least one memory storing instructions, and
at least one processor configured to execute the instructions to:
acquire an image;
detect a person region estimated to be a person from the image;
calculate likelihood of the person detected at a time of detecting the person region;
mask at least a part of the person region in a case where the calculated likelihood of the person is equal to or more than a threshold;
detect a face region estimated to be a face of the person from the image in which the person region is detected; and
mask at least a part of the person region and the face region in a case where the calculated likelihood of the person is less than the threshold and the person region and the face region satisfy a predetermined condition.

2. The image processing device according to claim 1, wherein the predetermined condition is that a degree of overlap between the person region and the face region is equal to or more than a threshold.

3. The image processing device according to claim 1, wherein the predetermined condition is that a distance between the person region and the face region is equal to or less than a threshold.

4. The image processing device according to claim 1, wherein the masking includes filling, mosaicing, or blurring on at least a part of the person region and the face region.

5. The image processing device according to claim 1, wherein the masking includes disposing an avatar on the person region and the face region.

6. An image processing method comprising:
acquiring an image;
detecting a person region estimated to be a person from the image;
calculating likelihood of the person detected at a time of detecting the person region;
masking at least a part of the person region in a case where the calculated likelihood of the person is equal to or more than a threshold;
detecting a face region estimated to be a face of the person from the image in which the person region is detected; and
masking at least a part of the person region and the face region in a case where the calculated likelihood of the person is less than the threshold and the person region and the face region satisfy a predetermined condition.

7. A non-transitory computer-readable medium storing a program that causes a computer to:
acquire an image;
detect a person region estimated to be a person from the image;
calculate likelihood of the person detected at a time of detecting the person region;
mask at least a part of the person region in a case where the calculated likelihood of the person is equal to or more than a threshold;
detect a face region estimated to be a face of the person from the image in which the person region is detected; and
mask at least a part of the person region and the face region in a case where the calculated likelihood of the person is less than the threshold and the person region and the face region satisfy a predetermined condition.
